(19) United States
(12) Patent Application Publication
(10) Pub. No.: US 2016/0278367 A1
(43) Pub. Date: Sep. 29, 2016

(54) Pesticidal Composition

(71) Applicant: Eden Research PLC, Easingwold, York, North Yorkshire (GB)

(72) Inventors: Alexander John ABREY, Easingwold, York, North Yorkshire (GB); Kenneth William Brooks, Easingwold, York, North Yorkshire (GB); Sir Arthur Benjamin Norman Gill, (US); Clive Roland Newitt, (US)

(21) Appl. No.: 15/037,187

(22) PCT Filed: Nov. 21, 2013
(86) PCT No.: PCT/GB2013/053076

§ 371 Date: May 17, 2016

(51) Int. Cl. A01N 25/00; A01N 61/00; A01N 25/28; A01N 25/10

(52) U.S. Cl. CPC A01N 25/006; A01N 25/10; A01N 61/00; A01N 25/28

(57) ABSTRACT

There is described a pesticidal composition comprising an insect feeding stimulant and a pesticidally effective amount of one or more terpenes.

### FIELD OF THE INVENTION

The present invention relates to a novel composition for the control of pests, to methods of their preparation and to uses related thereto.

More particularly the invention relates to compositions for the control of pests including insects and especially hematophagous parasites, such as mosquitoes and similar species. The invention relates to compositions which stimulate insect feeding and a method for using such compositions for insect control.

### BACKGROUND TO THE INVENTION

Numerous attempts have been made to develop effective means and methods for controlling insect infestations, including traps, poisonous sprays, powders and compounds controlling the reproductive cycle of insects.

For example, insecticidal compositions have been developed containing boric acid, usually in the form of sodium tetraborate, which is a colourless, odourless white powder or transparent crystals have been developed for controlling infestations of ants and cockroaches. Compositions containing boric acid are not directly consumed by the insects, but the boric acid adhered to the body of the insect. An insect whose body collects a sufficient amount of boric acid soon dies from the poisonous effect which boric acid has upon it. Boric acid generally kills insects by acting as a stomach poison and by absorbing the waxes that would normally protect insects from drying out.

Bait compositions containing boric acid for direct consumption by insects are known in the art, for example, in the control of infestations of insects that may forage for food, such as, ants or cockroaches.

However, if humans are exposed to boric acid used as a pesticide, undesirable symptoms may occur which include difficulty in breathing, headache, lethargy, nausea, coughing, and wheezing. The most significant health concerns associated with exposure to boric acid and borates are their ability to reduce successful reproduction.

Furthermore, there is a need for an insecticide which is suitable for the treatment of infestations of parasitic hematophagous arthropods. Parasitic hematophagous arthropods and the diseases they transmit are an increasing problem in animal husbandry and human health. Parasitic hematophagous arthropods include biting and/or blood sucking arthropods, especially ectoparasite species, such as insects and arachnids, e.g. ticks, mites, fleas, mosquitoes, midges, oestridae (bot flies) and hypodermae (warble flies), etc.

For example, West Nile virus is a disease spread by mosquitoes and the number of cases in the USA is increasing. 2012 saw one of the worst outbreaks on record with some 134 people in the US having died from West Nile Virus and more than 3,000 others falling sick. WNV is now considered to be endemic in the USA.

Although WNV is on track to become the worst outbreak on record, other insect-borne diseases are also threatening the human population, especially in the USA. Other insect-borne diseases threatening the USA include, for example, Dengue fever, which has been reported in three US states and in Virginia cases of Chikungunya and Rift Valley Fever (RVF), which both originated in Africa, are increasing.

Also, ticks often carry one or more diseases and often transmit such diseases from one host to another. In humans ticks may transmit a variety of diseases such as Lyme disease and Human Granulocytic Anaplasmosis. The problems caused by ticks are also increasing. In the USA in 2007 there were 57,000 confirmed cases of Lyme disease in humans alone and many other cases of tick borne disease (TBD). In the UK the first case of tick borne encephalitis was reported in 2008. Lyme disease, which is one of the most common tick borne diseases in humans, is classified as an emerging infectious disease (EID), that is, an infectious disease whose incidence has increased in the past 20 years and threatens to increase in the near future.

International Patent application No. WO 1999/037148 describes the use of terpenes in formulations for the treatment of lice infestations. The terpenes are found to be effective, in aqueous solutions, in killing lice by contacting the terpenes with the exoskeleton of the lice.

It has now been found that by combining one or more terpenes with an insect feeding stimulant, e.g. an edible bait, pests will ingest a pesticidal amount of the one or more terpenes, thus killing the pests.

### SUMMARY OF THE INVENTION

Therefore, according to a first aspect of the invention there is provided a pesticidal composition comprising an insect feeding stimulant and a pesticidally effective amount of one or more terpenes.

Thus, the pesticidal composition of the invention comprises an insect feeding stimulant component and a pesticidal component. The composition may comprise an intimate mixture of the insect feeding stimulant component and the pesticidal component.

The insect feeding stimulant may comprise a conventionally known bait material or pest or insect food material that is considered palatable to one or more types of pests to which the pesticidal composition is targeted.

However, a preferred insect feeding stimulant material for use in the composition of the present invention comprises one or more sugars. It will be understood by the person skilled in the art that any sugar may be used, including any monosaccharide, disaccharide, trisaccharide, oligosaccharide or polysaccharide. Monosaccharides that may be used in accordance with the present disclosure include any tetrose, pentose, hexose or heptose. Tetroses that may be used include erythose and threose. Pentoses that may be used include arabinose, ribose, ribulose, xylose, xylulose and lyxose. Hexoses that may be used include allose, altrose, fructose, galactose, glucose (dextrose), glulose, idose, mannose, sorbose, talose, and tagatose. Heptoses that may be use include seduheptulose. Disaccharides that may be used include sucrose, maltose, trehalose, lactose and melibiose. Trisaccharides that may be used include raffinose. Polysaccharides that may be used e.g. glycogen, starch, and dextran. Any of the foregoing sugars may be used in more or less pure form. In addition, it will be understood that mixtures of sugars may be used. In one particular embodiment of the present invention the sugar that is used is may be a monosaccharide or a disaccharide as hereinbefore described. In particular, for example, the disaccharides sucrose or lactose may be used. In another example, the monosaccharides, fructose and glucose may be used.

The amount of insect feeding stimulant, e.g. sugar, in the composition of the invention may vary, depending upon, inter alia, the target pest, the particular sugar, the terpene, etc. Thus, for example, the amount of sugar on the composition may be from about 0.5% to about 50% w/w of the total composition. Therefore, the amount of sugar may be from about 1% to about 95% w/w, from about 2% to about 95% w/w, from about 3% to about 95% w/w, from about 4% to about 95% w/w, from about 5% to about 95% w/w, from about 10% to about 95% w/w, from about 15% to about 95% w/w, from about 20% to about 95% w/w, from about 25% to about 95% w/w, from about 30% to about 95% w/w, from about 35% to about 95% w/w from about 40% to about 95% w/w, from about 45% to about 95% w/w, from about 50% to about 95% w/w, from about 55% to about 95% w/w, from about 60% to about 95% w/w, from about 65% to about 95% w/w, from about 70% to about 95% w/w, from about 75% to about 95% w/w, from about 80% to about 95% w/w, from about 85% to about 95% w/w or from about 90% to about 95% w/w from about 45% to about 95% w/w.

The insect feeding stimulant bait material may comprise additional ingredients, such as flour and vegetable oil. The flour may be selected from one or more of cotton seed flour, soybean flour, rice flour, wheat flour and rape seed (canola), etc. Such flours in combination with the other ingredients of the present invention provide an effective insect feeding stimulant.

When the insect feeding stimulant bait material includes a vegetable oil the vegetable oil may be selected from one or more of cotton seed oil, peanut oil, corn oil, safflower oil and canola (rape seed) oil, etc.

The one or more terpenes employed in the composition of the present invention preferably comprise those which are naturally occurring and generally unmodified. Thus, the preferred terpenes are classified as GRAS (Generally Regarded as Safe) by the Environmental Protection Agency in the USA and have been used for many years in the flavour and fragrance industries. The terpenes which are exempted from US regulations and which are listed in EPA regulation 40 C. F.R. Part 152 (incorporated herein by reference in its entirety) are suitable for use in this invention. The building block of the terpenes is the 16 hydrocarbon isoprene (C₅H₈)ₙ.

The term “terpene” as used herein refers not only to terpenes of formula (C₅H₈)ₙ, but also encompasses terpene derivatives, such as terpene aldehydes or terpene polymers. Natural and synthetic terpenes are included, for example monoterpenes, sesquiterpenes, diterpenes, triterpenes, and tetraterpenes. In addition, reference to a single name of a compound will encompass the various isomers of that compound. For example, the term citral includes the cis-isomer citral-a (or geranial) and the trans-isomer. citral-b (or neral). Particularly suitable terpenes for use in the present invention include those selected from the group consisting of citral, pinene, nerol, b-ionone, geraniol, carvacrol, eugenol, carvone (for example L-carvone), terpeniol, anethole, camphor, menthol, thymol, limonene, nerolidol, farnesol, phytol, carotene (vitamin A₁), squalene, thymol, tocotrienol, perillyl alcohol, borneol, myrcene, simene, carene, terpenene, linalool and mixtures thereof.

The terpenes used in the present invention may have the general structure C₁₀H₁₆.

The terpene component may comprise a terpene selected from the group consisting of one or more of geraniol, thymol, citral, carvone (for example L-carvone), eugenol and b-ionone, or a mixture thereof. Thus, the terpene component may comprise geraniol. Alternatively, the terpene component may comprise thymol. Alternatively, the terpene component may comprise citral. Alternatively, the terpene component may comprise carvone (for example L-carvone). Alternatively, the terpene component may comprise eugenol. Alternatively, the terpene component may comprise b-ionone.

It should be noted that terpenes are also known by the names of the extract or essential oil which contain them, e. g. lemongrass oil (contains citral).

International Patent application No. WO 1999/037148 describes the use of a terpene blend in an aqueous shampoo at a concentration of 4%. It is further stated that experiments have shown that the formulation, diluted with distilled water to a 2% terpene blend concentration is also pediculocidal.

The term pesticide or pesticidal shall generally be construed as meaning “insecticide” or “insecticidal”. However, these terms shall not be limited to meaning compositions that are fatal only to insects, but should include, for example, compositions that are fatal all parasitic hematophagous arthropods, such as ticks, mites, fleas, mosquitoes, midges, etc.

One advantage of the present invention is that by combining the one or more terpenes with an insect feeding stimulant, e.g. an edible bait, pests will ingest the one or more terpenes when consuming the bait. Due to the ingestion of the terpene by the pest, the required pesticidal amount may optionally be lower than that described in the prior art. Thus, the pesticidal amount of the one or more terpenes in the composition of the present invention may comprise from about 0.1% w/w to about 50% w/w of the composition. Therefore, the pesticidal amount of the one or more terpenes in the composition may be ≦50% w/w, ≦45% w/w, ≦40% w/w, ≦35% w/w, ≦30% w/w, ≦25% w/w, ≦20% w/w, ≦15% w/w, ≦10% w/w, ≦9% w/w, ≦8% w/w, ≦7% w/w, ≦6% w/w, ≦5% w/w, ≦4% w/w, ≦3% w/w, ≦2% w/w or ≦1% w/w of the composition.

As hereinbefore described, a particular target of the compositions of the present invention is hematophagous arthropods, such as hematophagous pests, especially blood sucking parasites. Such parasites include, for example, insects and arachnids. The term “hematophagous arthropods” shall include all arthropods, e.g. insects and arachnids, which take a blood meal from a suitable host, such as insects, ticks, lice, fleas, mites, mosquitoes, etc. In particular it includes those arthropods that are known to transmit diseases in mammals, especially man, such as, mosquitoes, including, the genus Culex, e.g. Culex pipiens (the common house mosquito); the genus Aedes, e.g. Aedes aegypti (yellow fever mosquito); the genus anopheles, e.g. Anopheles stephensi and Anopheles gambiae; midges, including genus Culicoides, e.g. Culicoides impunctatus (Highland midge) and Culicoides molestus; ticks, including genus Ixodes, such as Ixodes holocyclus; Sandflies, including genus Lutzomyia and Phlebotomine; etc. Therefore the invention especially provides a parasiticidal composition.

In a preferred embodiment of the present invention there is provided a pesticidal composition comprising a insect feeding stimulant material and a pesticidally effective amount of one or more terpenes, wherein the one or more terpenes is in encapsulated form.

The one or more terpenes can be taken up and stably encapsulated within hollow microparticles, such as hollow glucan particles or hollow yeast cell wall particles. Such particles are advantageous in that, inter alia, encapsulation of terpenes into such particles can be achieved by incubation of the particles with the terpene. The terms hollow glucan particles or hollow yeast cell wall particles is intended to mean glucan microparticles or yeast cell particles wherein intracellular components have been substantially removed and in which the glucan particles or yeast cell particles are dead.

The term “hollow glucan particle” as used herein includes any hollow particle comprising glucan, e.g. β-glucan, as a structural component. Thus, in particular, the term includes yeast cell walls (in purified or crude forms) or hollow whole glucan particles. Glucan particles are generally 2-4 μm spherical, hollow, porous shells extracted from a yeast, such as Baker's yeast, Saccharomyces cerevisae. The surface of the glucan particles is composed primarily of 1,3-β-glucan and the particles. The hollow cavity of the GPs allows for efficient absorption and encapsulation of molecules, such as terpenes. The term “cell wall particle” refers to a particle comprising the wall of a cell (in a purified or crude form), wherein glucan is not a structural component.

Suitable particles include the cell walls of plant, algal, fungal or bacterial cells. Cell wall particles generally retain the shape of the cell from which they are derived, and thus, like a hollow glucan particle, provide a hollow central cavity suitable for encapsulating the terpene component.

For this aspect of the present invention it is necessary that the hollow glucan particle or cell wall particle is able to stably encapsulate the terpene component. In general this means the hollow glucan particle or cell wall particle must be able to maintain its structure during incubation with the terpene component (generally the terpene component is at a relatively high concentration), and that terpene component must be able to migrate into the particle. Hollow glucan particles and cell wall particles are generally formed from relatively inert materials and are porous, and thus it can be assumed that, in general, hollow glucan particles and cell wall particles will be able to encapsulate a terpene component.

The compositions according to the present invention can provide the following advantages:—maximise terpene payload;—minimise unencapsulated payload; control payload stability; control payload release kinetics;—creation of a solid form of a liquid terpene to increase the mass and uniformity;—simplify handling and application of terpenes; and mask the smell and taste of the terpene.

Particularly suitable hollow glucan particles or cell wall particles are fungal cell walls, preferably yeast cell walls. Yeast cell walls are preparations of yeast cells that retain the three-dimensional structure of the yeast cell from which they are derived. Thus they have a hollow structure which allows the terpene component to be encapsulated within the yeast cell walls. The yeast walls may suitably be derived from Baker's yeast cells (available from Sigma Chemical Corp., St. Louis, Mo.). Yeast cell wall particles with desirable properties can also be obtained from Biorigin (Sao Paolo, Brazil) under the trade name Nutricell MOS 55. These particles are a spray dried extract of S. cerevisiae.

Alternative particles are those known by the trade names SAF-Mannan (SAF Agri, Minneapolis, Minn.) and Nutrex (Sensient Technologies, Milwaukee, Wis.). These are hollow glucan particles that are the insoluble waste stream from the yeast extract manufacturing process. During the production of yeast extracts the soluble components of partially autolysed yeast cells are removed and the insoluble residue is a suitable material for terpene loading. The amount of beta 1,3-glucan in the hollow glucan particles may vary and may be from about 25 to about 90% beta 1,3-glucan w/w. SAF-Mannan hollow glucan particles comprise approximately 25-35% beta 1,3-glucan w/w. A key attribute of these materials are that they contain more than 10% lipid w/w and are very effective at absorbing terpenes. In addition, as a waste stream product they are a relatively cheap source of hollow glucan particles.

Alternative hollow glucan particles which have higher purity are those produced by Nutricepts (Nutricepts Inc. , Burnsville, Minn.) and ASA. Biotech. These particles have been alkali extracted, which removes additional intracellular components as well as removes the outer mannoprotein layer of the cell wall yielding a particle of 50-65% w/w glucan.

Higher purity hollow glucan particles are the WGP particles from Biopolymer Engineering. These particles are acid extracted removing additional yeast components yielding a product 75-85% w/w glucan.

Very high purity hollow glucan particles are Adjuvax® from Alpha-beta Technology, Inc. (Worcester, Mass.) and microparticulate glucan from Novogen (Stamford, Conn.).

These particles are organic solvent extracted which removes residual lipids and so the particles comprise more than 90% w/w glucan.

In some embodiments a high purity glucan particle or cell wall particle may be required, for example where strict control over possible contaminants is required. In these instances the higher purity particles would be preferred over other less pure products. For other embodiments, the less pure particles would be preferred for economic reasons; those particles have also been. found to be more effective at absorbing terpenes.

Preferably the hollow glucan particle or cell wall particle has a slight lipid content, such as 1 or 2% w/w lipid. A slight lipid content can increase the ability of the particle to encapsulate the terpene component. Preferably the lipid content of the hollow glucan particle or cell wall particle is 5% w/w or greater, more preferably 10% w/w or greater.

Optionally the terpene component of the present invention can be associated with a surfactant. The surfactant can be non-ionic, cationic, or anionic.

Examples of suitable surfactants include sodium lauryl sulphate, polysorbate 20, polysorbate 80, polysorbate 40, polysorbate 60 polyglyceryl ester, polyglyceryl monooleate, decaglyceryl monocaprylate, propylene glycol dicaprilate, triglycerol monostearate, polyoxyethylenesorbitan, monooleate, Tween®, Span® 20, Span® 40, Span® 60, Span® 80, Brig 30 or mixtures thereof. The surfactant acts to hold the terpene component in an emulsion and also assists encapsulation of the terpene component into the hollow glucan particle or cell. wall particle.

The terpene component of the present invention can comprise a single terpene or a mixture of terpenes as hereinbefore defined. Mixtures of terpenes can result in synergistic effects.

One suitable terpene is citral. Another suitable terpene is a combination of terpenes. A combination of one or more of geraniol, thymol and eugenol may also be suitable, e.g. geraniol and thymol; or geraniol and eugenol; or thymol and eugenol; or geraniol, thymol and eugenol. When a combination of terpenes is used the ration of the terpenes may vary.

Certain terpene formulations which may be suitable include (percentages are w/w):

100% thymol;

100% geraniol;

100% eugenol;

100% citral; and

100% L-carvone.

Other terpene formulations which may be suitable include (percentages are w/w):

100% thymol;

50% geraniol and 50% thymol;

50% eugenol and 50% thymol;

33% geraniol, 33% eugenol and 33% thymol;

33% eugenol, 33% thymol and 33% citral;

25% geraniol, 25% eugenol, 25% thymol and 25% citral; and

20% geraniol, 20% eugenol, 20% citral, 20% thymol and 20% L-carvone.

Accordingly a terpene component comprising any of the above formulations is particularly suitable for use in the present invention.

In one embodiment the terpene component includes one or more terpenes which contain oxygen. Citral, for example citral 95, is an oxygenated C₁₀H₁₆ terpene, C₁₀H₁₆O CAS No. 5392-40-5 (3,7-dimethyl-2,6-octadien-1-a1). A stable suspension of citral can be formed up to about 2500 ppm. Citral can be made into a solution at up to about 500 ppm. A stable suspension of hollow glucan particles incorporating citral of 25 ppt citral can be made.

The encapsulated terpene component of the composition of the invention, i.e. the microparticle/terpene component of the insect feeding stimulant composition, can comprise 1 to 99% by volume terpenes and 1 to 99% microparticle, e.g. hollow glucan particles or hollow cell wall particles. More specifically the composition can comprise about 10% to about 67% w/w terpenes, about 0.1-10% surfactant and about 40-90% hollow glucan particles or cell wall particles.

Suitably a composition of the present invention comprises from about 500 to about 10,000 ppm hollow glucan particles or cell wall particles, where the particles contain from about 1 to about 67% terpene component. Preferably the composition comprises from about 1000 to about 2000 ppm hollow glucan particles or cell wall particles, where the particles contain from about 10 to about 50% terpene component.

Specific terpenes which are fatal to hematophagous arthropods include, for example one or more of, redistilled limonene, beta-ionone, linalool, geraniol, eugenol, myrcene and carvone.

Concentrations of hollow glucan particles or hollow cell wall particles encapsulating terpenes of 1, 5, 10, 20, 30, 40, 50, 60, 70, 80, 90, 100, 110, 125, 130, 140, 150, 160, 175, 190, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1100, 1250, 1375, 1425, 1500, 1600, 1750, or 2000 ppm can be used as effective concentrations in the compositions and methods of the current invention. Even higher concentrations (up to 25 ppt, i.e. parts per thousand) can be made and may be useful in the current invention.

The composition of the present invention can comprise between about 1 ppm and about 25 ppt (25000 ppm) of the terpene component, preferably 100 to 2000 ppm of the terpene component, for example, 250, 500, 1000, 2000 ppm thereof.

The terpenes, surfactants, and other components of the invention may be readily purchased or synthesised using techniques generally known to synthetic chemists.

Redistilled limonene 45% w/w;

Beta-ionone 25% w/w;

Linalool 10% w/w;

Geraniol 10% w/w;

Eugenol 5% w/w;

Myrcene or Carvone 5% (according to preferred fragrance only) w/w.

Optionally the composition can comprise other active compounds in addition to the terpene component, for example other antimicrobial agents, enzymes, or the like.

Optionally the composition can comprise a further active agents in addition to the terpene component, for example an additional insecticidal agent. Suitable additional insecticide components include, but shall not be limited to, pyrethroid, pyrethrin, or a combination thereof. More preferably, the insect control agent comprises at least one pyrethroid such as allethrin, d-allethrin, d-trans allethrin, alfoxylate, bioresmethrin, cyfluthrin, beta-cyfluthrin, cyhalothrin, lambda cyhalothrin, gamma cyhalothrin, bifenthrin, cypermethrin, beta cypermethrin, zeta cypermethrin, cyphenothrin, deltamethrin, tetramethrin, esfenvalerate, fenfluthrin, fenopropathrin, fenpyrithrin, fenvalerate, fluorocythrin, furamethrin, fluvalinate, imiprothrin, permethrin, phencyclate, phenothrin, prallethrin, resmethrin, s-bioallethrin, tau-fluvalinate, tefluthrin, tetrallethrin, tralocythrin and tralomethrin or a combination thereof

Additionally, any combination of the above pesticides can be used.

The composition can comprise an antioxidant to reduce oxidation of the terpene. An example of such an anti-oxidant might be rosemary oil, vitamin C or vitamin E.

The composition of the present invention can be in the form of a dry powder. The composition can be provided in combination with an agriculturally, food or pharmaceutically acceptable carrier or excipient in a liquid, solid or gel-like form.

For solid compositions, suitable carriers include pharmaceutical grades of mannitol, lactose, starch, magnesium stearate, sodium saccharin, talc, cellulose, glucose, sucrose, magnesium carbonate, and the like. Suitably the formulation is in tablet or pellet form. Additionally, conventional agricultural carriers could also be used.

A pellet, tablet or other solid form of the composition can preferably also contain a dispersal agent which promotes dispersal of the composition when placed into a liquid, e. g. water. Suitable dispersal agents include xanthan gum, maltodextrin, alginates, or the like.

Liquid compositions can, for example, be prepared by dispersing the composition in water, saline, aqueous dextrose, glycerol, ethanol, or the like, to form a solution or suspension. If desired, these compositions can contain minor amounts of non-toxic auxiliary substances such as wetting or emulsifying agents, pH buffering agents (for example, sodium acetate, sorbitan monolaurate, triethanolamine sodium acetate or triethanolamine oleate). The methods of preparing such liquid compositions are known, or will be apparent, to those skilled in this art. A liquid composition could be prepared by dispersing the composition in a liquid food or drink material. Additionally a suitable liquid agricultural excipient could be used.

Conventionally known carriers, aqueous, powder or oily bases, thickeners, and the like can be used as necessary or desirable.

The present invention further provides a method of killing an arthropod, said method comprising the step of contacting said arthropod with a composition comprising a hollow glucan particle or cell wall particle encapsulating a terpene component.

Suitable compositions are those defined in more detail above.

The amount of terpene administered in the above method should clearly be sufficient to achieve the desired result, i.e. to be fatal to the hematophagous arthropod, but should not be at a level which will induce serious toxic effects in mammals, especially humans.

Incorporation of a terpene component in a hollow glucan particle or cell wall particle can reduce the rate of terpene release and degradation, thus increasing the duration of action of the terpene.

Therefore, according to this aspect of the invention there is provided a pesticidal composition comprising an insect feeding stimulant and a pesticidally effective amount of one or more terpenes wherein said one or more terpenes is encapsulated in hollow glucan particles or cell wall particles.

Such compositions are advantageous in that, inter alia, the insect feeding stimulant material and the glucan particles or cell wall particles may be ingested by the pest.

The yeast cell wall particles may comprise, for example, Baker's yeast cell walls that are derived from baker's yeast cells and are composed of the insoluble biopolymers β-1,3-glucan, β-1,6-glucan, mannan and chitin. They are typically 2-4 micron in diameter microspheres with a shell wall that is only 0.2-0.3 micron thick surrounding an open cavity. This material has considerable liquid holding capacity, typically absorbing 5-25 times its weight in liquid. The shell is sufficiently porous that payloads up to 150,000 Daltons in size can pass through the outer shell and be absorbed into the hollow cavity of the spherical particle. Baker's yeast cell walls have several unique properties, including heat stability (e.g. to 121° C.), shear stability, pH stability (e.g. pH 2-12), and at high concentrations they do not build significant viscosity. In addition to its physical properties this composition contains natural and healthy dietary fibres that deliver cardiovascular and immunopotentiation health benefits.

Yeast cell walls are generally prepared from yeast cells by the extraction and purification of the insoluble particulate fraction from the soluble components of the yeast cell. The fungal cell walls can be produced from the insoluble by-product of yeast extract manufacture. Furthermore, the yeast cells can be treated with an aqueous hydroxide solution, without disrupting the yeast cell walls, which digests the protein and intracellular portion of the cell, leaving the yeast cell wall component devoid of significant protein contamination, and having substantially the unaltered cell wall structure of β(1-6) and β(1-3) linked glucans. A more detailed description of whole glucan particles and the process of preparing them is described by Jamas et al. in U.S. Pat. No. 4,810,646 and in U.S. Pat. No. 5,082,936 and U.S. Pat. No. 4,992,540. U.S. Pat. No. 6,242,594, assigned to Novogen Research Pty Ltd., describes a method of preparing yeast glucan particles by alkali extraction, acid extraction and then extraction with an organic solvent and finally drying. U.S. Pat. No. 5,401,727, assigned to AS Biotech-Mackzymal, discloses the methods of obtaining yeast glucan particles and methods of using them to promote resistance in aquatic animals and as an adjuvant for vaccinations. U.S. Pat. No. 5,607,677, assigned to Alpha-Beta Technology Inc., discloses the use of hollow whole glucan particles as a delivery package and adjuvant for the delivery of a variety of pharmaceutical agents. The teachings of the abovementioned patents and applications are incorporated herein by reference.

Other types of yeast and fungi cells have cell walls that do not contain glucan. The cell walls of such yeast and fungi can be isolated by similar techniques to those mentioned above to obtain cell wall particles.

Additionally, the cells of many plants, algae, bacteria and other micro-organisms also comprise a cell wall. The structure and composition of the cell wall varies between micro-organism, but in general it is a robust and relatively inert structure. It is possible to obtain cell wall particles derived from such cells through conventional techniques, such as those mentioned above in relation to yeast. Thus the term “cell wall particles” shall include yeast cell wall particles and cell wall particles derived from cells of plants, algae, bacteria, etc as hereinbefore described.

Terpenes can be taken up and stably encapsulated within the microparticles, e.g. the hollow glucan particles or hollow cell wall particles. Encapsulation of terpenes into such particles can be achieved by incubation of the particles with the terpene.

The term “hollow glucan particle” as used herein includes any hollow particle comprising glucan as a structural component. Thus, in particular, the term includes yeast cell walls (in purified or crude forms) or hollow whole glucan particles. The term “cell wall particle” refers to a particle comprising the wall of a cell (in a purified or crude form) , wherein glucan is not a structural component.

Suitable particles include the cell walls of plant, algal, fungal or bacterial cells. Cell wall particles generally retain the shape of the cell from which they are derived, and thus, like a hollow glucan particle, provide a hollow central cavity suitable for encapsulating the terpene component.

For this aspect of the present invention it is necessary that the hollow glucan particle or cell wall particle is able to stably encapsulate the terpene component. In general this means the hollow glucan particle or cell wall particle must be able to maintain its structure during incubation with the terpene component (generally the terpene component is at a relatively high concentration), and that terpene component must be able to migrate into the particle. Hollow glucan particles and cell wall particles are generally formed from relatively inert materials and are porous, and thus it can be assumed that, in general, hollow glucan particles and cell wall particles will be able to encapsulate a terpene component.

The compositions according to the present invention can provide the following advantages:
maximise terpene payload;
minimise unencapsulated payload;
control payload stability;
control payload release kinetics;
creation of a solid form of a liquid terpene to increase the mass and uniformity;
simplify handling and application of terpenes; and
mask the smell and taste of the terpene.

Particularly suitable hollow glucan particles or cell wall particles are fungal cell walls, preferably yeast cell walls. Yeast cell walls are preparations of yeast cells that retain the three-dimensional structure of the yeast cell from which they are derived. Thus, they have a hollow structure which allows the terpene component to be encapsulated within the yeast cell walls. The yeast walls may suitably be derived from Baker's yeast cells (available from Sigma Chemical Corp., St. Louis, Mo.). Yeast cell wall particles with desirable properties can also be obtained from Biorigin (Sao Paolo, Brazil) under the trade name Nutricell MOS 55. These particles are a spray dried extract of S. cerevisiae.

Alternative particles are those known by the trade names SAF-Mannan (SAF Agri, Minneapolis, Minn.) and Nutrex (Sensient Technologies, Milwaukee, Wis.). These are hollow glucan particles that are the insoluble waste stream from the yeast extract manufacturing process. During the production of yeast extracts the soluble components of partially autolysed yeast cells are removed and the insoluble residue is a suitable material for terpene loading. These hollow glucan particles comprise approximately 25-35% beta 1,3-glucan w/w. A key attribute of these materials are that they contain more than 10% lipid w/w and are very effective at absorbing terpenes. In addition, as a waste stream product they are a relatively cheap source of hollow glucan particles.

Alternative hollow glucan particles which have higher purity are those produced by Nutricepts (Nutricepts Inc., Burnsville, Minn.) and ASA .Biotech. These particles have been alkali extracted, which removes additional intracellular components as well as removes the outer mannoprotein layer of the cell wall yielding a particle of 50-65% w/w glucan.

Higher purity hollow glucan particles are the WGP particles from Biopolymer Engineering. These particles are acid extracted removing additional yeast components yielding a product 75-85% w/w glucan.

Very high purity hollow glucan particles are Adjuvax™ from Alpha-beta Technology, Inc. (Worcester, Mass.) and microparticulate glucan from Novogen (Stamford, Conn.). These particles are organic solvent extracted which removes residual lipids and so the particles comprise more than 90% w/w glucan.

In some embodiments a high purity glucan particle or cell wall particle may be required, for example where strict control over possible contaminants is required. In these instances .the higher purity particles would be preferred over other less pure products. For other embodiments, the less pure particles would be preferred for economic reasons; those particles have also been.—found to be more effective at absorbing terpenes.

Preferably the microparticles, e.g. the hollow glucan particle or cell wall particle has a slight lipid content, such as 1 or 2% w/w lipid. A slight lipid content can increase the ability of the particle to encapsulate the terpene component. The lipid content of the microparticles, e.g. the hollow glucan particle or hollow cell wall particle may be ≧1% w/w, or ≧2% w/w, or ≧3% w/w, or ≧4% w/w, or ≧5% w/w, or ≧6% w/w, or ≧7% w/w, or ≧8% w/w, or ≧9% w/w, or ≧10% w/w, or ≧15% w/w, or ≧20% w/w, or ≧25%. Thus, the lipid content may be from about 1% to about 25% w/w, or from about 2% to about 20% w/w, or from about 5% to about 15% w/w, e.g. about 10% w/w.

Optionally the terpene component of the present invention can be associated with a surfactant. The surfactant can be non-ionic, cationic, or anionic. Examples of suitable surfactants include sodium lauryl sulphate, polysorbate 20, polysorbate 80, polysorbate 40, polysorbate 60ι, polyglyceryl ester, polyglyceryl monooleate, decagiyceryl monocaprylate, propylene glycol dicaprilate, triglycerol monostearate, polyoxyethylenesorbitan, monooleate, Tween®, Span® 20, Span® 40, Span® 60, Span® 80, Brig 30 or mixtures thereof. The surfactant acts to hold the terpene component in an emulsion and also assists encapsulation of the terpene component into the hollow glucan particle or cell, wall particle.

The terpene component of the present invention can comprise a single terpene or a mixture of terpenes. Mixtures of terpenes can result in synergistic effects.

The terpene component may comprise a terpene selected from the group consisting of geraniol, thymol, citral, carvone (for example L-carvone) , eugenol and b-ionone.

The terpene component can suitably comprise thymol.

Another particularly suitable terpene is citral which has demonstrated particular efficacy.

A combination of geraniol, thymol and eugenol has demonstrated particular efficacy.

Other terpene formulations which have shown high efficacy include (percentages are w/w):
100% thymol;
50% geraniol and 50% thymol;
50% eugenol and 50% thymol;
33% geraniol, 33% eugenol and 33% thymol;
33% eugenol, 33% thymol and 33% citral;
25% geraniol, 25% eugenol, 25% thymol and 25% citral;
20% geraniol, 20% eugenol, 20% citral, 20%
   thymol and 20% L-carvone.

Accordingly a terpene component comprising any of the above formulations is particularly suitable for use in the present invention.

In one embodiment the terpene component includes one or more terpenes which contain oxygen. Citral, for example citral 95, is an oxygenated C₁₀H₁₆ terpene, C₁₀H₁₆O CAS No. 5392-40-5 (3,7-dimethyl-2,6-octadien-1-a1) . A stable suspension of citral can be formed up to about 2500 ppm. Citral can be made into a solution at up to about 500 ppm. A stable suspension of hollow glucan particles incorporating citral of 25 ppt citral can be made.

The composition of the invention can comprise 1 to 99% by volume terpenes, 0 to 99% by volume surfactant and 1 to 99% microparticles, e.g. hollow glucan particles or cell wall particles. More specifically the composition can comprise from about 10% to about 67% w/w terpenes, from about 0.1 to about 10% w/w surfactant and from about 40 to about 90% w/w microparticles, e.g. hollow glucan particles or cell wall particles.

Suitably a composition of the present invention comprises from about 500 to about 10,000 ppm microparticles, e.g. hollow glucan particles or cell wall particles, where the particles contain from about 1 to about 67% terpene component. Preferably the composition comprises from about 1000 to about 2000 ppm microparticles, e.g. hollow glucan particles or cell wall particles, where the microparticles contain from about 10 to about 50% w/w terpene component.

Specific compositions can include hollow glucan particles or cell wall particles encapsulating terpenes in water or standard 0.9% saline with up to 67% L-carvone, up to 67% eugenol, up to 67% citral, up to 67% thymol and L-carvone, up to 67% geraniol, or up to 67% citral and L-carvone and eugenol, and 1% Tween® 80; or hollow glucan particles or cell wall particles encapsulating terpenes in water or standard 0.9% saline with up to 67% citral and 1% Tween® 80; or hollow glucan particles or cell wall particles encapsulating terpenes in water or standard 0.9% saline with up to 67% citral, up to 67% L-carvone and eugenol, up to 67% eugenol, up to 67% geraniol, or up to 67% geraniol, thymol, and 1% Tween® 80.

Concentrations of hollow glucan particles or cell wall particles encapsulating terpenes of 1, 5, 10, 20, 30, 40, 50, 60, 70, 80, 90, 100, 110, 125, 130, 140, 150, 160, 175, 190, 200, 225, 250, 275, 300, 325, 350, 375, 400, 425, 450, 475, 500, 525, 550, 575, 600, 625, 650, 675, 700, 725, 750, 775, 800, 825, 850, 875, 900, 925, 950, 975, 1000, 1100, 1250, 1375, 1425, 1500, 1600, 1750, or 2000 ppm can be used as effective concentrations in the compositions and methods of the current invention. Even higher concentrations (up to 25 ppt, i.e. parts per thousand) can be made and may be useful in the current invention.

The composition of the present invention can comprise between about 1 ppm and about 25 ppt (25000 ppm) of the terpene component, preferably 100 to 2000 ppm of the terpene component, for example, 250, 500, 1000, 2000 ppm thereof.

The terpenes, surfactants, and other components of the invention may be readily purchased or synthesised using techniques generally known to synthetic chemists.

It is highly preferred that terpenes used in the present invention, for safety and regulatory reasons, are at least food grade terpenes (as defined by the United States FDA or equivalent national regulatory body outside the USA).

Optionally the composition can comprise further active agents in addition to the terpene component, for example a further insecticidal agent, or the like. Suitable insecticidal agents include natural insecticides, synthetic insecticides, chitinase, etc.

The composition of the present invention can be in the form of a dry powder. The composition can be provided in combination with an acceptable carrier or excipient in a liquid, solid or gel-like form.

For solid compositions, suitable carriers include, but shall not be limited to, mannitol, lactose, starch, magnesium stearate, sodium saccharin, talc, cellulose, glucose, sucrose, magnesium carbonate, and the like.

The composition can also contain a dispersal agent which promotes dispersal of the composition when placed into a liquid, e.g. water. Suitable dispersal agents include xanthan gum, maltodextrin, alginates, or the like.

Liquid compositions can, for example, be prepared by dispersing the composition in water, saline, aqueous dextrose, glycerol, ethanol, or the like, to form a solution or suspension. If desired, these compositions can contain minor amounts of auxiliary substances such as wetting or emulsifying agents, pH buffering agents (for example, sodium acetate, sorbitan monolaurate, triethanolamine sodium acetate or triethanolamine oleate). The methods of preparing such liquid compositions are known, or will be apparent, to those skilled in this art. A liquid composition could be prepared by dispersing the composition in an agricultural excipient.

The composition of the invention may contain binders and lubricants. Fine powders or granules may contain diluting, dispersing and/or surface active agents and can be presented in water or in a syrup.

The composition can conveniently be in a dry state. Non-aqueous solutions or suspensions of the composition are also suitable and may contain suspending agents. Where desirable or necessary, preserving, suspending, thickening, or emulsifying agents can be included.

The composition may also contain buffers, diluents and other suitable additives.

Examples of non-aqueous solvents are propylene glycol, polyethylene glycol, vegetable oils (such as olive oil), and injectable organic esters (such as ethyl oleate). Aqueous carriers include water, alcoholic/aqueous solutions, emulsions, or suspensions, including saline and buffered media. Other vehicles include sodium chloride solution, Ringer's dextrose, dextrose and sodium chloride, lactated Ringer's, or fixed oils.

Preservatives and other additives can also be present such as, for example, antimicrobials, anti-oxidants, chelating agents, and the like.

Conventional carriers, aqueous, powder or oily bases, thickeners, and the like can be used as necessary or desirable.

The present invention also provides a method of preparing a pesticidal composition comprising an insect feeding stimulant material and a pesticidally effective amount of one or more terpenes as hereinbefore described which comprises mixing a terpene component with a insect feeding stimulant material.

The present invention further provides a method of preparing a pesticidal composition comprising an insect feeding stimulant material and a pesticidally effective amount of one or more terpenes comprises mixing a terpene component with an insect feeding stimulant material.

The present invention further provides a method of preparing a pesticidal composition comprising an insect feeding stimulant and a pesticidally effective amount of one or more terpenes as hereinbefore described wherein the terpene component is in encapsulated form which comprises preparing a microparticle, e.g. a hollow glucan particle or hollow cell wall particle encapsulating a terpene component, said method comprising the steps of;
a) providing a terpene component;
b) providing a microparticle, e.g. a hollow glucan particle or cell wall particle;
c) incubating the terpene component with the microparticle under suitable conditions for terpene encapsulation; and
d) recovering the microparticle encapsulating the terpene component; and
e) mixing the encapsulated terpene component with an insect feeding stimulant.

Optionally the above method can further comprise the step of drying the particles encapsulating the terpene component. Drying may be achieved in a number of ways and mention may be made of freeze drying, fluidised bed drying, drum drying or spray drying, all of which are well known processes.

In step a) of the above method, the terpene component is suitably provided as a suspension in an aqueous solvent, and optionally in the presence of a surfactant. Suitably the solvent is water. A suitable surfactant is Tween-80 (polyoxyethylenesorbitan monooleate), and preferably the surfactant is present at a concentration of about 0.1 to 10% by volume of the total reaction mixture, more preferably about 1%. Alternatively the terpene component may be provided as a true solution in a solvent, e. g. water. A true solution of terpene in water can be obtained by mixing the terpene in water at high shear until a true solution is obtained.

Publication No WO 03/020024 provides further details of forming true solutions of terpenes in water.

In step b) of the above method, the hollow glucan particle or cell wall particle is suitably provided as a suspension in water or other suitable liquid.

Suitably the suspension comprises approximately 1 to 1000 mg particles per ml, preferably 200 to 400 mg/ml. Alternatively the particles may be provided as a dry powder and added to the terpene-surfactant suspension.

Alternatively the particles are provided in sufficient liquid to minimally hydrate the particles, but not in significant excess. The term “hydrodynamic volume” (HV) is used to describe the volume of liquid required to minimally hydrate the particles. Thus suitably the particles are provided with a volume ranging from the HV and a volume of 1.5 times the HV (1.5 HV). This makes the subsequent drying step more efficient. Also, where a low volume of liquid is used (i.e. around HV to 1.5 HV), it is also possible to extrude the finished product into pellet or noodle form, which is convenient for fluidised bed drying.

It has been found that the terpene component can become encapsulated by the hollow glucan particle or cell wall particle at room temperature. The rate of encapsulation is, however, increased at 37 C but the temperature should be kept below the boiling point or denaturing temperature of any component of the composition. Suitable conditions for step c) of the above method are therefore atmospheric pressure at a temperature of 20 to 37 C. Optimisation of the conditions for a particular encapsulation reaction will be a matter of routine experimentation.

Optionally the above method can further comprise the step of drying the particles encapsulating the terpene component. Drying may be achieved in a number of ways and mention may be made of freeze drying, fluidised bed drying, drum drying or spray drying, all of which are well known processes.

The amount of terpene administered in the above method should clearly be sufficient to achieve the desired result, i.e. killing the arthropod, but should not be at a level which will induce serious toxic effects to other species, especially humans.

The amount of composition administered will, of course, be dependent on the manner of administration, on the arthropod being targeted, etc, However, as hereinbefore described, because the terpene component is likely to be ingested by the arthropod target, a generally lower amount of terpene may be used.

In a further embodiment the present invention provides a method of killing an arthropod, said method comprising the step of administering in a fatally effective dose a composition comprising an insect feeding stimulant material and a terpene component to the arthropod.

In a preferred embodiment of this aspect of the invention the method comprises administering a composition wherein the terpene component is in encapsulated form as hereinbefore described.

Suitable compositions are those defined in more detail above.

Terpenes alone in suspension or solution, however, are somewhat unstable and degrade rapidly in the soil environment, thus losing efficacy.

Incorporation of a terpene component in a microparticle, e.g. a hollow glucan particle or cell wall particle, can reduce the rate of terpene release and degradation, thus increasing the duration of action of the terpene.

Thus, the compositions of the present invention may be advantageous in that, inter alia, they prevent or minimise the spread of diseases transmitted by hematophagous arthropods. Such diseases include, but shall not be limited to, In particular it includes those arthropods that are known to transmit diseases in mammals, especially man, such as mosquitoes, including, the genus Culex, e.g. Culex pipiens (the common house mosquito); the genus Aedes, e.g. Aedes aegypti (yellow fever mosquito); the genus anopheles, e.g. Anopheles stephensi and Anopheles gambiae; midges, including genus Culicoides, e.g. Culicoides impunctatus (Highland midge) and Culicoides molestus; ticks, including genus Ixodes, such as Ixodes holocyclus; Sandflies, including genus Lutzomyia and Phlebotomine; etc. Therefore the invention especially provides a parasiticidal composition suitable for the treatment, alleviation or especially the prevention of West Nile virus, encephalitis, filariasis, dengue fever, yellow fever, malaria, borreliosis, Lyme disease, Leishmaniasis, bluetongue, African horse sickness, and the like.

1. A pesticidal composition comprising an insect feeding stimulant and a pesticidally effective amount of one or more terpenes.

2. (canceled)

3. A pesticidal composition according to claim 1 wherein the insect feeding stimulant material comprises one or more sugars.

4. A pesticidal composition according to claim 1 wherein the insect feeding stimulant material comprises one or more of a monosaccharide, disaccharide, trisaccharide, oligosaccharide or polysaccharide.

5. A pesticidal composition according to claim 1 wherein the insect feeding stimulant material comprises from about 0.5% to about 50% w/w of the total pesticidal composition.

6.-7. (canceled)

8. A pesticidal composition according to claim 1 wherein the terpene is present in a pesticidal amount.

9. A pesticidal composition according to claim 8 wherein the pesticidal amount of the terpene is from about 0.1% w/w to about 50% w/w.

10.-11. (canceled)

12. A pesticidal composition according to claim 1 wherein the pest targeted is one or more hematophagous arthropods.

13.-14. (canceled)

15. A pesticidal composition according to claim 12 wherein the hematophagous arthropods are selected from the group of insects and arachnids.

16. A pesticidal composition according to claim 12 wherein the hematophagous arthropods are selected from the group consisting of ticks, lice, fleas, mites, mosquitoes, midges and sandflies.

17.-20. (canceled)

21. A pesticidal composition according to claim 1 wherein the one or more terpenes is in encapsulated form.

22. A pesticidal composition according to claim 1 wherein the one or more terpenes is encapsulated within hollow microparticles.

23. A pesticidal composition according to claim 22 wherein the hollow microparticles are hollow glucan particles or hollow yeast cell wall particles.

24.-25. (canceled)

26. A pesticidal composition according to claim 22 wherein the hollow microparticles are hollow glucan particles.

27. A pesticidal composition according to claim 26 wherein the hollow glucan particles comprise from about 25-90% beta 1,3-glucan w/w.

28.-31. (canceled)

32. A pesticidal composition according to any one of claim 22 wherein the lipid content of the microparticle is ≧1% w/w.

33. (canceled)

34. A pesticidal composition according to claim 1 wherein the terpene component is associated with a surfactant.

35.-56. (canceled)

57. A pesticidal composition according to claim 1 wherein the pesticidal component of the composition comprises from about 10% to about 67% w/w terpenes.

58. (canceled)

59. A pesticidal composition according to claim 1 wherein the composition comprises a further active agent.

60.-64. (canceled)

65. A method of preparing a pesticidal composition comprising an insect feeding stimulant material and a pesticidally effective amount of one or more terpenes, said method comprising mixing a terpene component with an insect feeding stimulant material.

66. (canceled)

67. A method of killing an arthropod, said method comprising the step of administering in a fatally effective dose a composition comprising an insect feeding stimulant material and a terpene component to the arthropod.

68. A method of killing an arthropod according to claim 67 wherein the terpene component is in encapsulated form.

69. (canceled)
